(19) United States
(12) Patent Application Publication
(10) Pub. No.: US 2006/0174065 A1
(43) Pub. Date: Aug. 3, 2006

(54) System and method for annotating an ultrasound image

(76) Inventors: David J. Kuzara, Chelmsford, MA (US); Cynthia Brown, Tewksbury, MA (US)

Correspondence Address: PHILIPS INTELLECTUAL PROPERTY & STANDARDS, P.O. BOX 3001, BRIARCLIFF MANOR, NY, 10510, US

(21) Appl. No.: 10/559,211

(22) PCT Filed: Jun. 7, 2004
(86) PCT No.: PCT/IB04/50855

§ 371 Date: Dec. 6, 2005

Related U.S. Application Data
(60) Provisional application No. 60/477,201, filed on Jun. 10, 2003.

(51) Int. Cl. G06F 13/28

(52) U.S. Cl. 711/123

(57) ABSTRACT

A system and method are provided for annotating data displayed on a display device. The system includes a processing unit for processing data and providing the processed data to the display device for displaying a portion thereof, and further generating a cursor for display by the display device and accessing a data set including a plurality of labels. The system further includes a user input device for transmitting a series of user request signals to the processing unit upon manipulation of the user input device with a user's hand, and a switch in proximity to the user input device for transmitting mode selection signals to the processing unit for selecting one of a cursor movement mode and an annotation mode. The switch is located sufficiently proximate the user input device for being selectively switched by the user's hand during manipulation of the user input device. When the cursor movement mode is selected, the series of user request signals control movement of the cursor on the display. When the annotation mode is selected, the series of user request signals control selection of a label of the plurality of labels for display at approximately the current cursor location for annotating the displayed data.

### FIELD OF THE INVENTION

The present invention generally relates to diagnostic ultrasound systems, and in particular to a system and method for entering text annotation to an ultrasound image using a user input device.

### BACKGROUND OF THE INVENTION

Diagnostic ultrasound systems use an ultrasonic transducer to generate ultrasonic waves and direct the waves to a region of interest and sense reflected waves. The generated and reflected waves are compared and used to generate image data corresponding to the region of interest. The image data is typically processed by a data processing unit for generating a display to be displayed on a display device. The display may be a video display that changes over time.

A user may freeze the video display for selecting the data displayed at a selected time. The image displayed in the frozen display may be stored and/or the user may enter commands via a user input device to command the data processing unit to perform operations on the image data that is displayed, such as measuring, outlining or labeling structures within the region of interest that is displayed. Typically the frozen display includes a cursor that indicates a position on the frozen display. The cursor may be moved by manipulating a user input device, such as a pointing device (e.g., a trackball or mouse), that is coupled to the data processing unit.

Current methods available for adding labels to the image, such as for labeling of structures within the region of interest that is displayed, allow the user to scroll through a list of predefined labels. In one currently available method, the user manipulates a trackball to place the cursor on a selected location of the display where a label is desired, then operates a soft key to display a menu of labels, manipulates the trackball to move the cursor to point to a label for selecting the label, and presses an Enter hard key to place the selected label at the selected location.

In another currently available method, a knob coupled to the data processing device, but located away from the pointing device, is used to scroll through a list of predefined labels. The above methods require the user to perform a series of hand motions and/or to move his hand away from the trackball area for operating a knob or a hard and/or soft key.

Accordingly, there exists a need for a system and method for allowing a user to use a user input device to select a location on a display and a predefined label for placing the selected label at the selected location using minimal hand motions and without moving his hand away from the user input device for enabling fast annotation of an image, such as an ultrasound image.

### SUMMARY OF THE INVENTION

The present invention provides a system for annotating data displayed on a display device. The system includes a processing unit for processing data and providing the processed data to the display device for displaying a portion thereof, and further generating a cursor for display by the display device and accessing a data set including a plurality of labels. The system further includes a user input device for transmitting a series of user request signals to the processing unit upon manipulation of the user input device with a user's hand, and a switch in proximity to the user input device for transmitting mode selection signals to the processing unit for selecting one of a cursor movement mode and an annotation mode. The switch is located sufficiently proximate the user input device for being selectively switched by the user's hand during manipulation of the user input device. When the cursor movement mode is selected, the series of user request signals control movement of the cursor on the display. When the annotation mode is selected, the series of user request signals control selection of a label of the plurality of labels for display at approximately the current cursor location for annotating the displayed data.

A method is also provided for annotating displayed data on a display device. The method includes the steps of receiving a mode selection signal for selecting a cursor control mode or an annotation mode, receiving sensed signals corresponding to movement associated with a user input device; and processing the sensed signals. The processing step includes the steps of, when the cursor control mode is selected, controlling movement of a cursor displayed with the data in accordance with the processed sensed signals, and when the annotation mode is selected, controlling selection of a label of a plurality of labels and displaying the selected label at a location in proximity to the cursor in accordance with the processed sensed signals.

A computer-readable medium is further provided storing a set of programmable instructions configured for execution by at least one processor of an ultrasound imaging system for receiving the mode selection signal and the sensed signals and processing the received signals in accordance with the method described above.

### BRIEF DESCRIPTION OF THE DRAWINGS

Various embodiments of the invention will be described herein below with reference to the figures wherein:

FIG. 1 is a block diagram of the system according to the present invention;

FIG. 2 is a block diagram of a processing unit according to the present invention;

FIG. 3 is a flowchart showing procedural steps executed by a curser control module in accordance with the present invention; and

FIG. 4 is a flowchart showing procedural steps executed by an annotation module in accordance with the present invention.

### DESCRIPTION OF THE PREFERRED EMBODIMENTS

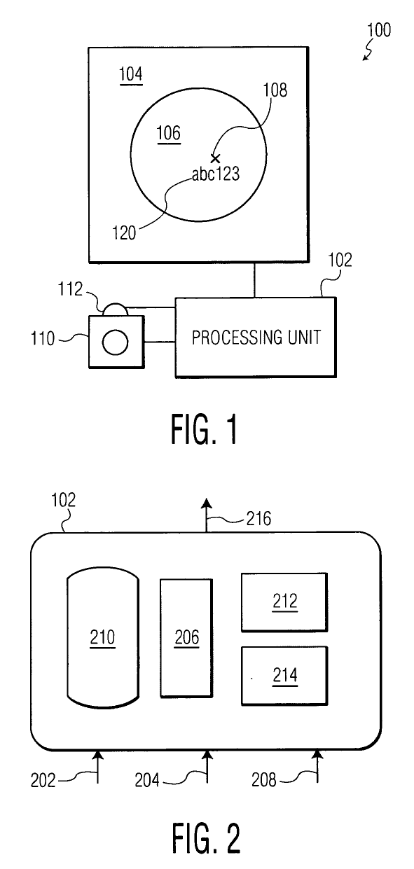

With reference to FIG. 1, there is shown a block diagram of a data processing system for processing and displaying data according to the present invention and designated generally by reference numeral 100. The system 100 includes a processing unit 102 coupled to a display device 104 for providing data to the display device 104 for displaying a display 106 thereof and for generating a cursor 108 which is displayed on the display 106. The processing unit further accesses a plurality of predetermined labels. A user input device (UID) 110 is provided for enabling a user to enter at least one user request to the processing unit 102 by performing a continuous manipulation with the UID 110.

A switch 112 is provided with or adjacent to the UID 110 for transmitting mode selection signals to the processing unit for enabling the user to select one of a cursor movement mode and an annotation mode, where the user holding the UID 110 with one hand can operate the switch 112 without removing his hand from the UID 110. When the cursor movement mode is selected, the at least one user request controls movement of the cursor 108 on the display 106. When the annotation mode is selected, the at least one user request controls selection of a label 120 of the plurality of predetermined labels for display of the selected label 120 at the cursor's current location on the display 106.

Preferably, the system 100 is an ultrasound display system receiving ultrasound image data to be processed from an ultrasound imaging apparatus including a transducer for transmitting ultrasonic energy waves into a region of interest and receiving echoes thereof, wherein the ultrasound image data is derived from a comparison of the transmitted and received ultrasound waves. Accordingly, the display 106 is preferably a display of an image of the region of interest. The display device 104 is a commercially available device such as a monitor capable of being used with a personal computer. The processing unit 102 may be a commercially available processing unit for processing of ultrasound image data, or a customized personal computer. Coupling between the processor to the display device 104 and the UID 110 and the switch 112, respectively, may be wired or wireless, or a combination thereof.

The UID 110 is a commercially available UID, preferably a trackball, or alternatively a mouse, a joy stick, a touch pad, etc., that is capable of continual manipulations using the UID 110 for generating more than one user request. The UID 110 may be manipulated by the user in a continual motion, such as for causing rotation of a ball or cylinder, movement of a laser, or the manipulation may include a continual motion of an object on a touchpad. The UID 110 includes sensor(s) for sensing the motion caused by the manipulation. The sensors generate sensor signals which correspond to the sensed motion, and the sensor signals are transmitted as user request signals to the processing unit 102.

The switch 112 is preferably a toggle switch that is positioned adjacent to the UID 110 or is integrated into a housing of the UID 110. For example, the UID 110 is a trackball housed in a housing, where the trackball is operated by the palm of the user's hand, and the switch 112 is provided on the housing of the trackball so that the switch 112 is positioned within reach of a finger of the user while his palm is on the trackball. In another example, the switch 112 is positioned below the trackball, and the switch 112 is activating by the user applying downward pressure with his palm for depressing the trackball, thereby activating the switch 112.

The switch 112 generates a mode select signal in accordance with activation of the switch 112, and the mode selection signal is sent to the processing unit 102. The switch 112 may be operatively integrated into the UID 110. Transmission of the mode selection signal may be provided via the same medium, or alternatively via a different medium, that the sensor signals are transmitted from the UID 110 to the processing unit 102. For example, in a wired coupling from the UID 110 and the switch 112 to the processing unit 102, the sensor signals and the mode selection signals may be sent via a single wire, distinct respective wires that are included in one cable, or via distinct respective wires that are included in respective cables.

With reference to FIG. 2, processing unit 102 is shown. The processing unit 102 receives user request signals 202 from the UID 110, mode selection signals 204 from the switch 112 and data 208 that are to be processed and displayed. Data 208 are received from a storage unit (not shown) such as a hard drive, an external drive, such as a CD-ROM drive, etc., or data 208 may be received from an apparatus that is generating the data 208; preferably, an ultrasound imaging apparatus. The processing unit 102 generates display data 216 in accordance with the received signals and data, and transmits the display data 216 to the display device 104 shown in FIG. 1.

The processing unit 102 includes at least one processor 206, an internal storage unit 210 and software modules including cursor control module 212 and annotation module 214, where the software modules each include programmable instructions executable on the processor 206. The processor 206 may be a commercially available processor chip. Storage unit 210 includes at least one storage device, such as a hard drive, ROM, RAM, cache memory, etc. The data 208 may be stored in storage unit 210 prior to processing by the processing unit 102. The plurality of predetermined labels are stored in storage unit 210 or an external storage unit.

The plurality of predetermined labels may have been previously entered by an administrator or user by entering and storing individual labels and/or storing at least one label from a source such as an accessible database, unloaded software or downloaded software. It is contemplated that the plurality of predetermined labels stored in the storage unit 210 may be divided into one or more subsets, so that the user may select a subset to be accessed during an annotation procedure.

When a mode selection signal 204 is received, the processor 208 determines the mode indicated by the mode selection signal 204. Preferably, the processor 208 sends a signal to control an indicator (not shown) to indicate which mode is selected, where the indicator is one or more LEDs on the housing of the UID 110, a symbol displayed on the display 106, etc. The cursor control module 212 is executed when the mode indicated by the mode selection signal 204 is the cursor control mode.

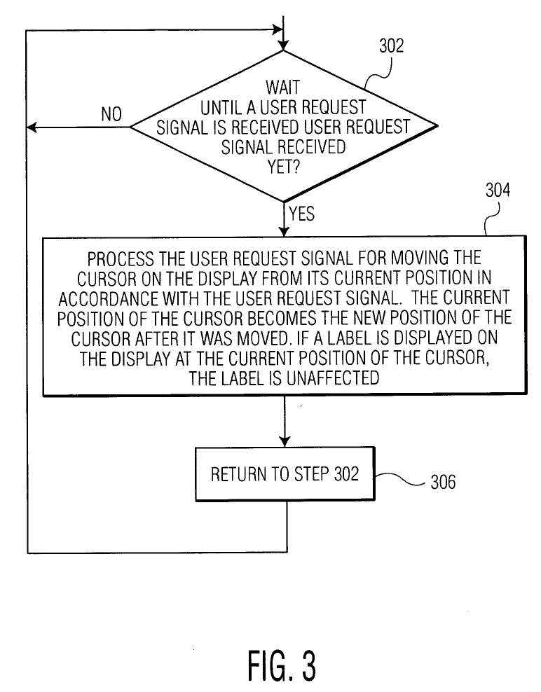

FIG. 3 shows the procedural steps executed by the cursor control module 212. At step 302, a wait step is executed for waiting until a user request signal is received. When a user request signal is received, control passes to step 304. At step 304, the user request signal is processed for moving the cursor 108 on the display 106 from its current position in accordance with the user request signal. It is known in the art to receive sensor signals from a UID, such as a trackball, mouse, joystick or touchpad, and to move the cursor an amount that is proportional to the displacement sensed due to movement associated with manipulation with the UID 110. The current position of the cursor 108 becomes the new position of the cursor 108 after it was moved. If a label 120 is displayed on the display 106 at the current position of the cursor 108, the label 120 is unaffected. At step 306 control returns to step 302.

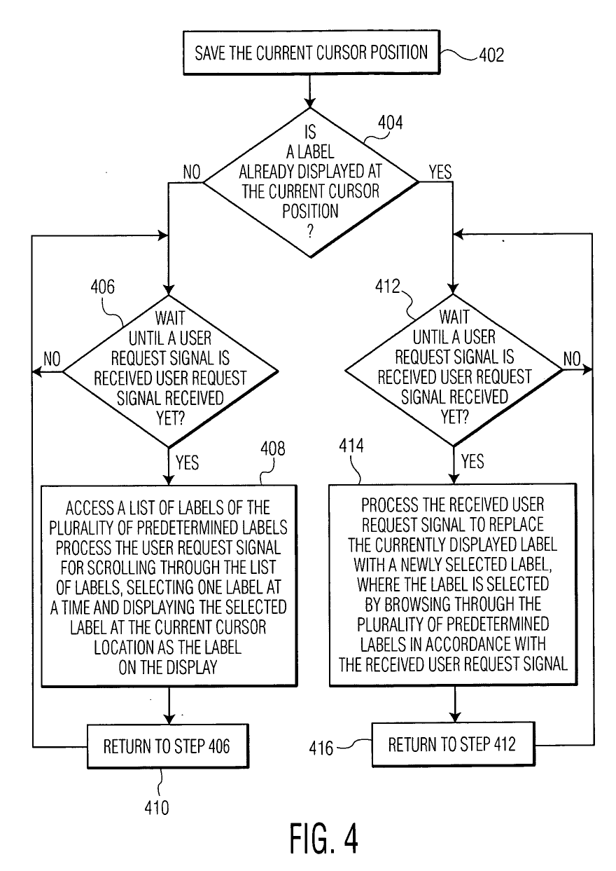

The annotation module 214 is executed when the mode indicated by the mode selection signal 204 is the annotation mode. FIG. 4 shows the procedural steps executed by the annotation module 214. At step 402, the current cursor position is saved. At step 404, a determination is made as to whether or not a label is already displayed at the current cursor position. If no label is displayed at the current label position, control passes to step 406 where a wait step is executed for waiting until a user request signal is received. When a user request signal is received, control passes to step 408. At step 408, the plurality of predetermined labels is accessed where the plurality of predetermined labels is preferably presented to the user as a list of labels, which may be only partially visible to the user, and where the visible part maybe only the selected labels. The entire set of stored labels or a subset thereof may be accessed, where selection of the subset may be made before selecting the annotation mode, and if a selection is not made, a default subset, such as the entire set, is accessed.

The user request signal is processed for scrolling through the list of labels, where while scrolling, one label of the list of labels is selected at a time and the selection changes as the user scrolls through, i.e., traverses, the list. Preferably, the selected label is displayed at the current cursor location as the label 120 on the display 106. Each time the selection changes the displayed label 120 changes. As the user scrolls through the list of labels, scrolling displacement is proportional to the displacement sensed due to movement associated with manipulation with the UID 110. At step 410, control returns to step 406.

If at step 404 it was determined that a label currently exists at the cursor's current location, control passes to step 412. At step 412, a wait step is executed for waiting until a user request signal is received. When a user request signal is received, control passes to step 414. Processing of the received user request signal at step 414 is in accordance with design choice, and the user may have the option to program the annotation module to execute in accordance with his preferences, or pop-up window may provide the user with the opportunity to select his preferences. For example, the currently displayed label may be replaced with a newly selected label in accordance with the received user request signal 202. Alternatively, the newly selected label may be displayed as a displayed label 120 in addition to the previously displayed label 120. At step 416, control returns to step 412.

It is contemplated that further functionality may be provided in addition to providing the above described method for enabling a user to select a label to be displayed at a selected cursor location using only the UID 110 and the switch 112 without moving his hand off of the UID 110. For example, it is contemplated that the list, or an adjustable portion of the list is displayed in a graphical user interface (GUI), such as a window that pops up when the annotation mode is selected. The display in the window allows the user to view a larger portion of the list than the selected label, and preferably to view which label is currently selected relative to other labels in the list.

The window may be provided with buttons for allowing the user to perform related functions, such as change the subset selection, add a new label to the plurality of predetermined labels, delete a displayed label, change to cursor control mode, add a second, third, etc. label to the current cursor location, enter a label to be displayed (but not necessarily stored), and browse through the list of labels without selecting a label. The user may enter selections and/or data into the window using the UID 110 or another UID, such as a keyboard.

It is further contemplated that all or a subset of the functions provided by the UID 110 may be provided by at least one other UID, such as a keyboard used with a GUI. Additional functions, not provided by the UID 110 may further be provided by other UIDs, such as entering at least one letter via a keyboard for quickly locating a desired label in the list of labels. It is further contemplated that a starting point when browsing a list may be selected prior to browsing, or once browsing has begun. For example, the starting point may be programmed by the user to be, for example, the first label in the list of labels, the last label selected, or a selected label specified by the user.

It will be understood that various modifications may be made to the embodiments disclosed herein. Therefore, the above description should not be construed as limiting, but merely as exemplifications of preferred embodiments. Those skilled in the art will envision other modifications within the scope and spirit of the claims appended hereto.

1. A system for annotating data displayed on a display device comprising:
a processing unit for processing data and providing the processed data to the display device for displaying a portion thereof on a display, and further generating a cursor for display by the display device and accessing a data set including a plurality of labels;
a user input device for transmitting a series of user request signals to the processing unit upon manipulation of the user input device with a user's hand; and
a switch in proximity to the user input device for transmitting mode selection signals to the processing unit for selecting one of a cursor movement mode and an annotation mode, wherein the switch is located sufficiently proximate the user input device for being selectively switched by the user's hand during manipulation of the user input device;
wherein when the cursor movement mode is selected, the series of user request signals control movement of the cursor on the display, and when the annotation mode is selected, the series of user request signals control selection of a label of the plurality of labels for display at approximately the current cursor location for annotating the displayed data.

2. The system according to claim 1, wherein the switch is integrated with the user input device.

3. The system according to claim 1, wherein in the annotation mode, the series of user request signals control selection of the label of the plurality of labels by traversing a list of the plurality of labels, and display of the selected label at approximately the current cursor location.

4. The system according to claim 3, wherein the user input device includes at least one sensor for sensing movements corresponding to the manipulation of the user input device, wherein the series of user request signals include data indicative of an amount of displacement of the sensed movements, and wherein an amount of traversal of the list of the plurality of labels is proportional to the amount of displacement.

5. The system according to claim 1, wherein in the annotation mode, the cursor remains at its current location.

6. The system according to claim 1, wherein the user input device is selected from the group consisting of a trackball, mouse, joystick and touchpad.

7. The system according to claim 1, wherein the system is an ultrasound system, and the data are ultrasound image data.

8. A method for annotating displayed data on a display device comprising the steps of:
receiving a mode selection signal for selecting a cursor control mode or an annotation mode;
receiving sensed signals corresponding to movement associated with a user input device; and
processing the sensed signals including the steps of:
when the cursor control mode is selected, controlling movement of a cursor displayed with the data in accordance with the processed sensed signals; and
when the annotation mode is selected, controlling selection of a label of a plurality of labels and displaying the selected label at a location in proximity to the cursor in accordance with the processed sensed signals.

9. The method according to claim 8, wherein the displayed data are image data obtained from an ultrasound imaging device.

10. The method according to claim 8, wherein when the annotation mode is selected, the cursor location is not changed.

11. The method according to claim 8, wherein when the cursor control mode is selected, a displayed label is not changed.

12. The method according to claim 8, wherein when the annotation mode is selected, further comprising the steps of traversing a list of the plurality of labels and selecting a label of the plurality of labels.

13. The method according to claim 12, wherein the sensed signals correspond to an amount of displacement associated with the movement, and wherein an amount of traversal of the list of the plurality of labels is proportional to the amount of displacement.

14. An apparatus for annotating displayed data comprising:
means for receiving a mode selection signal for selecting a cursor control mode or an annotation mode;
means for receiving sensed signals corresponding to movement associated with a user input device; and
means for processing the sensed signals including:
means for controlling movement of a cursor displayed with the data in accordance with the processed sensed signals when the cursor control mode is selected; and
means for controlling selection of a label of a plurality of labels and displaying the selected label at a location in proximity to the cursor in accordance with the processed sensed signals when the annotation mode is selected.

15. The apparatus according to claim 14, wherein the displayed data are image data obtained from an ultrasound imaging device.

16. The apparatus according to claim 14, wherein when the annotation mode is selected, the cursor location is not changed.

17. The apparatus according to claim 14, wherein when the cursor control mode is selected, a displayed label is not changed.

18. The apparatus according to claim 14, wherein the means for controlling selection of a label includes means for traversing a list of the plurality of labels and selecting a label of the plurality of labels.

19. The apparatus according to claim 18, wherein the sensed signals correspond to an amount of displacement associated with the movement, and wherein an amount of traversal of the list of the plurality of labels is proportional to the amount of displacement.

20. A computer readable medium storing a set of programmable instructions configured for execution by at least one processor for annotating displayed ultrasound image data, the programmable instructions comprising:
means for providing for receipt of a mode selection signal for selection of a cursor control mode or an annotation mode;
means for providing for receipt of sensed signals corresponding to movement associated with a user input device; and
means for providing for processing of the sensed signals including:
means for providing for control of movement of a cursor displayed with the data in accordance with the processed sensed signals when the cursor control mode is selected; and
means for providing for control of selection of a label of a plurality of labels and display of the selected label at a location in proximity to the cursor in accordance with the processed sensed signals when the annotation mode is selected.

21. A method for annotating displayed data comprising the steps of:
providing for receipt of a mode selection signal for selection of a cursor control mode or an annotation mode;
providing for receipt of sensed signals corresponding to movement associated with a user input device; and
providing for processing of the sensed signals including the steps of:
when the cursor control mode is selected, providing for control of movement of a cursor displayed with the data in accordance with the processed sensed signals; and
when the annotation mode is selected, providing for control of selection of a label of a plurality of labels and display of the selected label at a location in proximity to the cursor in accordance with the processed sensed signals.
